(19) United States
(12) Patent Application Publication
(10) Pub. No.: US 2022/0075627 A1
(43) Pub. Date: Mar. 10, 2022

(54) HIGHLY PARALLEL PROCESSING ARCHITECTURE WITH SHALLOW PIPELINE

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 17/465,949

(22) Filed: Sep. 3, 2021

Related U.S. Application Data
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/38; G06F 9/30; G06F 9/48; G06F 15/80

(52) U.S. Cl. CPC G06F 9/3885; G06F 9/3804; G06F 15/8053; G06F 9/4881; G06F 15/8046; G06F 9/30047

(57) ABSTRACT

Techniques for task processing using a highly parallel processing architecture with a shallow pipeline are disclosed. A two-dimensional array of compute elements is accessed. Each compute element within the array of compute elements is known to a compiler and is coupled to its neighboring compute elements within the array of compute elements. Control for the array of compute elements is provided on a cycle-by-cycle basis. The control is enabled by a stream of wide, variable length, microcode control words generated by the compiler. Relevant portions of the control word are stored within a cache associated with the array of compute elements. The control words are decompressed. The decompressing occurs cycle-by-cycle out of the cache over multiple cycles. A compiled task is executed on the array of compute elements, based on the decompressing. Simultaneous execution of two or more potential compiled task outcomes is provided.

### RELATED APPLICATIONS

This application claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a highly parallel processing architecture with shallow pipeline.

### BACKGROUND

Since the introduction of the first electronic computers, enterprises large and small have applied computers to myriad data processing tasks. Today, computers are indispensable tools that play crucial roles in the operations of the enterprises. Businesses, governments, hospitals, universities, research laboratories, retail establishments, and other organizations all support their operations by processing immense amounts of data. The data is collected into large aggregations or collections of data, commonly referred to as datasets. The datasets can be processed in various ways to support a given organization. The processing of the datasets has become so critical that the success or failure of a given organization is inextricably dependent upon whether the data can be processed to the benefit of the organization. If the processing of the data is performed economically and to the benefit of the organization, then the organization thrives. If not, then a dire outcome for the organization can be anticipated.

Vast resources are expended annually to support the data processing requirements of organizations. The data must be collected, stored, analyzed, processed, preserved, protected, backed up, and so on. Some organizations continue to support their data handing and processing needs “in-house” by building, supporting, and maintaining their own datacenters. In-house processing can be the preferred approach for asset management, security, and other reasons. Other organizations have taken advantage of now-common cloud-based computational facilities. These latter data handling and processing facilities, which can include multiple datacenters distributed across large geographic areas, provide computation, data collection, data storage, and other needs “as a service”. These services enable data processing and handling access for even small organizations that would otherwise be unable to equip, staff, and maintain their own datacenters. Whether supported in-house or contracted with cloud-based services, the organizations operate based on data processing.

Many and varied data collection techniques are used to collect data from a wide and diverse range of individuals. The individuals typically include clients, purchasers, patients, test subjects, citizens, students, and volunteers. At times the individuals are willing participants, while at other times they are unwitting subjects or even victims of data collection. Often used data collection strategies include “opt-in” techniques, where an individual signs up, registers, creates a user ID or account, or otherwise willingly and actively agrees to participate in the data collection. Other techniques are legislative, such as a government requiring citizens to obtain a registration number and to use that number while interacting with government agencies, law enforcement, or emergency services, among others. Additional data collection techniques are more subtle or intentionally hidden, such as tracking purchase histories, website visits, button clicks, and menu choices. Irrespective of the techniques used for the data collection, the collected data is highly valuable to the organizations that collected it. However collected, the rapid processing of this data remains critical.

### SUMMARY

A large numbers of processing jobs that are performed by organizations are critical to the missions of the organizations. The job processing typically includes running payroll or billing tasks, analyzing research data, assigning student grades, and so on. The job processing can also include training a processing network such as a neural network for machine learning. These jobs are highly complex and are composed of many tasks. The tasks can include loading and storing various datasets, accessing processing components and systems, executing data processing, and so on. The tasks themselves are typically based on subtasks which themselves can be complex. The subtasks can be used to handle specific jobs such as loading or reading data from storage, performing computations and other manipulations on the data, storing or writing the results data back to storage, handling inter-subtask communication such as data transfer and control, and so on. The datasets that are accessed are often immense, and can easily overwhelm processing architectures that are either ill-suited to the processing tasks or inflexible in their architectural designs. To greatly improve task processing efficiency and throughput, two-dimensional (2D) arrays of elements can be used for the processing of the tasks and subtasks. The 2D arrays include compute elements, multiplier elements, registers, caches, queues, controllers, decompressors, arithmetic logic units (ALUs), storage elements, and other components which can communicate among themselves. These arrays of elements are configured and operated by providing control to the array of elements on a cycle-by-cycle basis. The control of the 2D array is accomplished by providing control words generated by a compiler. The control includes a stream of control words, where the control words can include wide, variable length, microcode control words generated by the compiler. The control words are used to configure the array and to control the flow or transfer of data and the processing of the tasks and subtasks. Further, the arrays can be configured in a topology which is best suited to the task processing. The topologies into which the arrays can be configured include a systolic, a vector, a cyclic, a spatial, a streaming, or a Very Long Instruction Word (VLIW) topology, among others. The topologies can include a topology that enables machine learning functionality.

In disclosed techniques, task processing is accomplished using a highly parallel processing architecture with shallow pipeline. The highly parallel processing architecture is based on a two-dimensional (2D) array of compute elements. The compute elements can comprise CPUs, GPSs, processor cores, compute engine cores, and so on. The compute elements can further include elements that support the compute elements, such as storage elements, switching elements, caches, memories, and the like. The compute elements within the 2D array are controlled by providing control on a cycle-by-cycle basis. The control is accomplished by providing one or more control words. The control words can be provided as a stream of control words. The control words include variable length, microcode control words that can be generated by a compiler, an assembler, etc. Since providing control words to the elements of the 2D array can require substantial overhead due to memory and storage access, and data propagation timing, the control words can be compressed. The provided control words can be loaded into a cache memory, where the cache memory can be shared by more than one compute element. To further reduce memory accesses and data transfer overhead, single control words can be provided to more than one compute element. That is, a control word can be distributed to elements across a row or a column of the array of compute elements. A control word can be distributed across the entire array. The control words can also be used to selectively enable and disable compute elements that are not required for a given processing task. Selectively disabling compute elements can simplify data transfers within the array, reduce power consumption by the array, etc. The control words can be decompressed to enable control of one or more compute elements. The compute elements can include a single compute element, a row of compute elements, a column of compute elements, an array of compute elements, etc. Having configured compute elements within the 2D array, a compiled task can be executed. The decompressed control words can control the execution of the task, associated subtasks, and so on. The decompressed control words can further enable parallel processing within the 2D array.

A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, microcode control words generated by the compiler; decompressing the control words to enable control on a per element basis; and executing a compiled task on the array of compute elements, wherein the executing is based on the control words that were decompressed. In embodiments, the compute elements within the array of compute elements can have identical functionality such as word length, number and size of scratchpad memory elements, depth of register files, processing rates, etc. Embodiments include storing relevant portions of the control word within a cache associated with the array of compute elements. The cache can be based on a dual read, single write (2R1 W) cache. The 2R1 W cache enables two reads or fetches from the cache and one write or store to the cache to occur substantially simultaneously. The cache can include a hierarchical cache comprising multiple levels of cache storage such as L1, L2, and L3 cache levels. The cache enables high speed, local access to the portions of the control words used to control the compute elements and to other associated elements within the array. In embodiments, the decompressing can occur cycle-by-cycle out of the cache, thus providing control on a cycle-by-cycle basis to the elements of the 2D array. Depending on a particular variable-length control word, and the size of the control word, decompressing of a single control word can occur over multiple cycles. The multiple cycles can accommodate control word straddle over a cache line fetch boundary.

The control words that are provided enable parallel execution of tasks. The tasks can include substantially similar tasks that process different datasets (e.g., SIMD), two or more tasks that are independent of one another, and so on. In embodiments, simultaneous execution of two or more potential compiled task outcomes can be provided, where the two or more potential compiled task outcomes comprise a computation result or a routing control. The computational result can include a result of an arithmetic operation, a logical operation, and so on. The routing control can include a conditional branch, an unconditional branch, and the like. Since the outcome of the operation or a conditional branch is not known a priori, then the possible execution paths that can be taken can be executed in parallel. The two or more potential compiled outcomes can be controlled by the same control word. When the correct outcome of the operation or the branch decision is determined, then processing of the correct outcome is continued while processing of any alternative outcome is halted.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a highly parallel processing architecture with a shallow pipeline.

FIG. 2 is a flow diagram for task scheduling.

FIG. 3 shows a system block diagram for a highly parallel architecture with a shallow pipeline.

FIG. 4 illustrates compute element array detail.

FIG. 5 shows array row control decode.

FIG. 6 illustrates example encoding for a single control word row.

FIG. 7 shows example compressed control word sizes.

FIG. 8 is a table showing example decompressed control word fields.

FIG. 9 is a system diagram for task processing using a highly parallel processing architecture.

### DETAILED DESCRIPTION

Techniques for data manipulation using a highly parallel processing architecture with a shallow pipeline are disclosed. The tasks that are processed can perform a variety of operations including arithmetic operations, shift operations, logical operations including Boolean operations, vector or matrix operations, and the like. The tasks can include a plurality of subtasks. The subtasks can be processed based on precedence, priority, coding order, amount of parallelization, data flow, data availability, compute element availability, communication channel availability, and so on. The data manipulations are performed on a two-dimensional array of compute elements. The compute elements, which can include CPUs, GPUs, ASICs, FPGAs, cores, and other processing components, can be coupled to local storage, which can include cache storage. The cache, which can include a hierarchical cache, can be used for storing relevant portions of a control word, where the control word controls the compute element. Both compressed and decompressed control words can be stored in a cache, however storing decompressed control words in a cache is generally much less efficient. The compute elements can also be coupled to data cache, which can also be hierarchical, either directly or through queues, busses, and so on.

The tasks, subtasks, etc., are compiled by a complier. The compiler can include a general-purpose compiler, a hardware description-based compiler, a compiler written or “tuned” for the array of compute elements, a constraint-based compiler, a satisfiability-based compiler (SAT solver), and so on. The compiler generates a stream of wide, variable length, microcode control words. The length of a microcode control word can be adjusted by compressing the control word, by recognizing that a compute element is unneeded by a task so that control bits within that control word are not required for that compute element, etc. The control words can be used to route data, to set up operations to be performed by the compute elements, to idle individual compute elements or rows and/or columns of compute elements, etc. The compiled microcode control words associated with the compute elements are distributed to the compute elements, and the processing task is executed. In order to accelerate the execution of tasks, the executing can include providing simultaneous execution of two or more potential compiled task outcomes. In a usage example, a task can include a control word containing a branch. Since the outcome of the branch may not be known a priori to execution of the control word containing a branch, all possible control sequences that could be executed based on the branch can be simultaneously executed in the array. Then, when the branch outcome becomes known, the correct sequence of computations can be used, and the incorrect sequences of computations (e.g., the path not taken by the branch) can be ignored and/or flushed.

A highly parallel architecture with a shallow pipeline enables task processing. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Control for the array of compute elements is provided on a cycle-by-cycle basis. The cycle can include a clock cycle, a data cycle, a processing cycle, etc. The control is enabled by a stream of wide, variable length, microcode control words generated by the compiler. The microcode control word lengths can vary based on the type of control, compression, simplification such as identifying that a compute element is unneeded, etc. The control words, which can include compressed control words, are decoded on a per element basis within the compute element array. The control word can be decompressed to a level of fine control granularity, where each compute element (whether an integer compute element, floating point compute element, address generation compute element, write buffer element, read buffer element, etc.), is individually and uniquely controlled. Each compressed control word is decompressed to allow control on a per element basis. The decoding can be dependent on whether a given compute element is needed for processing a task or subtask; whether the compute element has a specific control word associated with it or the compute element receives a repeated control word (e.g., a control word used for two or more compute elements), and the like. A compiled task is executed on the array of compute elements, based on the decompressing. The execution can be accomplished by executing a plurality of subtasks associated with the compiled task.

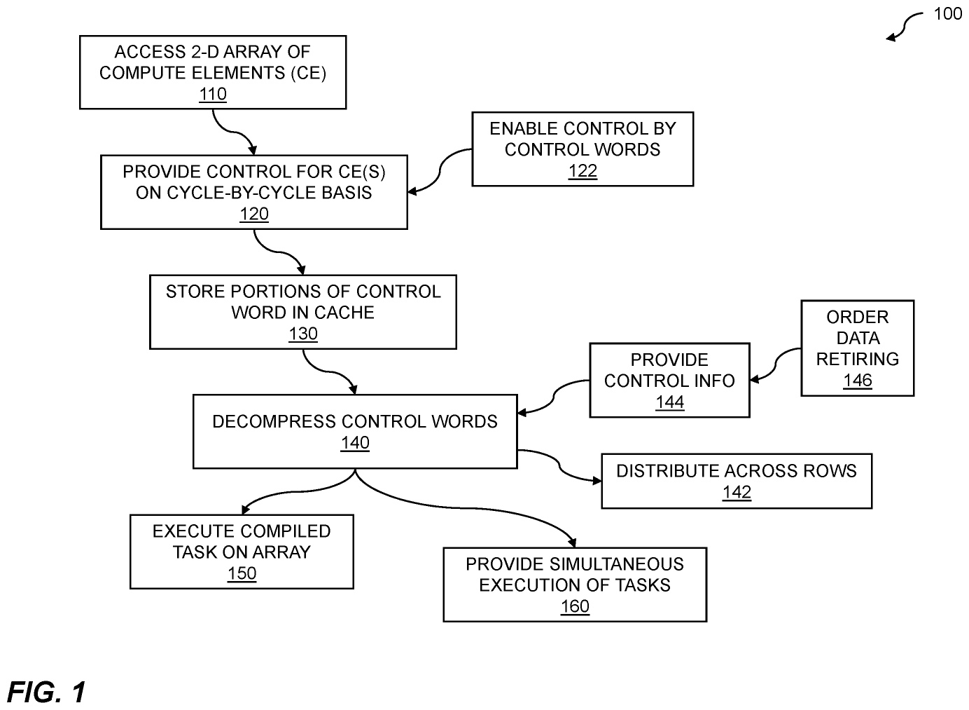

FIG. 1 is a flow diagram for a highly parallel processing architecture with a shallow pipeline. Clusters of compute elements (CEs), such as CEs assessable within a 2D array of CEs, can be configured to process a variety of tasks. The tasks can be based on a plurality of subtasks. The tasks can accomplish a variety of processing objectives such as data manipulation, application processing, and so on. The tasks can operate on a variety of data types including integer, real (floating point), and character data types; vectors and matrices; etc. Control is provided to the array of compute elements based on microcode control words generated by a compiler. The control words enable or idle various compute elements; provide data; route results between or among CEs, caches, and storage; and the like. The control words, which were compressed to reduce storage requirements, are decompressed on a per compute element basis. Because a control word spans the entire array, decompression is across the entire array on a per compute element basis. The decompressing enables execution of a compiled task on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can be configured in a topology, where the topology can be built into the array, programmed or configured within the array, etc. In embodiments, the array of compute elements is configured by the control word to implement one or more of a systolic, a Single Instruction Multiple Data (SIMD), a Multiple Instruction Multiple Data (MIMD), a vector, a cyclic, a spatial, a streaming, or a Very Long Instruction Word (VLIW) topology.

The compute elements can further include a topology suited to machine learning computation. The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; various queues; and so on. The compiler to which each compute element is known can include a general purpose compiler such as a C, C++, or Python compiler; a hardware-oriented compiler such as a VHDL or Verilog compiler; a compiler written for the array of compute elements; and so on. The coupling of each CE to its neighboring CEs enables sharing of elements such as cache elements or multiplier elements; communication between or among neighboring CEs; and the like. In addition, column busses can facilitate sharing between CEs and multiplier units and/or data cache elements.

The flow 100 includes providing control 120 for the array of compute elements on a cycle-by-cycle basis. The control can be provided in the form of a control word, where the control word can be provided by the compiler. The control word can be used to configure one or more CEs, to enable data to flow to or from the CE, to configure the CE to perform an operation, and so on. Depending on the type and size of task that is compiled to control the array of compute elements, one or more of the CEs can be controlled, while other CEs are unneeded by the particular task. A CE that is unneeded can be marked as unneeded so that the data, control word, etc. is neither needed in the control word nor sent to the CE after decompression. In embodiments, the unneeded compute element can be controlled by a single bit. In embodiments, a single bit can control an entire row of CEs by being decompressed into idle signals for each CE in the row. The single bit can be set for “unneeded”, reset for “needed”, or set for a similar usage of the bit to indicate when a particular CE is unneeded by a task. In the flow 100, the control is enabled by a stream of wide, variable length, microcode control words 122 generated by the compiler. The microcode control words can vary in length based on the operations of the CEs controlled by the control word, compression of the control word, and so on. A control word can be compressed by encoding fields or “bunches” of bits within the control word. In the event that a CE is unneeded by a task, then the control word may need only include the “not needed” bit while truncating or eliminating fields of the control word that would otherwise be filled if the CE were needed. In embodiments, the compiled task can include multiple programming loop instances circulating within the array of compute elements. The multiple programming loop instances can be used to accomplish parallelization of operations performed by the task. In other embodiments, the compiled task can include machine learning functionality. The machine learning can be accomplished by configuring the compute elements within the array. In embodiments, the machine learning functionality can include neural network implementation. The machine learning can be based on deep learning.

The flow 100 further includes storing relevant portions 130 of the control word within a cache associated with the array of compute elements. The cache can be closely associated with the array of compute elements in order to provide fast, local storage for control words, data, intermediate results, and so on. In embodiments, the cache can include a hierarchical cache. A hierarchical cache can include a hierarchy of levels of cache such as cache level 1 (L1), cache level 2 (L2), cache level 3 (L3), and so on. In a hierarchical cache, each successive level of cache can be larger and slower than the preceding level of cache. That is, L1 can be smaller and faster than L2, L2 can be larger and slower than L1 and smaller and faster than L3, and so on. The one or more levels of cache provide faster access to control words, data, intermediate results, and so on, than a main storage accessible to the array of CEs. In embodiments, L1, L2, and L3 caches can be four-way set associative. In other embodiments, the cache, such as the L2 cache, comprises a dual read, single write (2R1 W) cache. In a 2R1 W cache, two read or load accesses to the cache and one write or store can occur at substantially the same time. The cache can be used for other purposes. In embodiments, the cache can enable the control word to be distributed across a row of the array of compute elements. The control word can be distributed from the cache across one or more CEs in the row of the array of the CEs. In further embodiments, the distribution across a row of the array of compute elements can be accomplished in one cycle. In other embodiments, the 2R1 W cache supports simultaneous fetch of potential branch paths for the compiled task (discussed below). In embodiments, the initial parts of different branch paths can be simultaneously instantiated in consecutive control words.

The flow 100 includes decompressing the control words 140 on a per element basis. Recall that within a given row of compute elements within the array of compute elements, one or more CEs may be unneeded by a given task or subtask. In the flow 100, control words that are distributed 142 per element can include control words that enable a CE to access data, perform an operation, generate data, etc. In the cases of the unneeded CEs, if any, the control word only needs to provide a “not needed” bit for the CE, and if all compute elements in a row are not needed, then only one bit is needed for that entire row to indicate the row is idle. The decompressing can be performed on the control words stored in the cache. In embodiments, the decompressing occurs cycle-by-cycle out of the cache. The cycle-by-cycle decompressing can include decompressing a control word for a row of CEs, control words for each CE, control words shared by more than one CE, etc. In embodiments, decompressing of a single control word can occur over multiple cycles. The multiply cycles can include accessing a control word in the cache, decompressing a code word per CE, transmitting the decompressed code words to the CEs, etc. In further embodiments, the multiple cycles can accommodate control word straddle over a cache line fetch boundary. Since a control word can be of variable length, then the control word can be long enough to straddle the cache line fetch boundary. Accessing such control words can require multiple cycles. In other embodiments, the accessing, the providing, and the decompressing comprise a superstatic processor architecture. A superstatic processor architecture can include various components such as input and output components, a main memory, and a CPU that includes a control unit and a processor. The processor can further include registers and combinational logic.

The flow 100 can include providing 144 control information. The control information can be provided by the compiler, downloaded from a library of control information, uploaded by a user, and so on. The providing control information can include data handling. The flow 100 includes ordering data retiring 146. The data retiring can occur when data such as input or intermediate data is no longer required by a task or subtask. Data retiring can also occur due to a cache miss. That is, when data is sought for processing by a task and that data is not located within the cache, a higher level of cache, or in a queue to load data into the cache, then a cache miss occurs. The cache miss can cause the data within the cache to be “retired”, flushed, or written back, and new data to be accessed within a higher-level cache or from main storage. Data retirement can be based on latency. In a usage example, a task can require a multiplication operation which can be performed on a multiplier element. The data required by the multiplier element must be available within an amount of time, and the product generated by the multiplier element must also be generated within an amount of time subsequent to data availability. Thus, resources such as the multiplier element must be “consumed” by performing a multiplication, or “retired” because the multiplication did not occur within a window of time.

The flow 100 includes executing a compiled task 150 on the array of compute elements, based on the decompressing. The task and any subtasks associated with the task can be executed on the CEs within the array. The executing can include reading or loading data, processing data, writing or storing data, and so on. The executing is based on the control word. The executing can occur during a single cycle or can extend over multiple cycles. The flow 100 further includes providing simultaneous execution 160 of two or more potential compiled task outcomes. A task can include a decision point, where the decision point can be based on data, a result, a condition, and so on. The decision point can generate the two or more potential compiled task outcomes. In embodiments, the two or more potential compiled task outcomes comprise a computation result or a routing control. A compiled task outcome can include executing one sequence of control words based on a condition; executing a second sequence of control words based on a different, negative, or unmet condition; and so on. In embodiments, the two or more potential compiled outcomes can be controlled by the same control word. To accelerate execution of the task, the code sequences associated with the potential compiled task outcomes can be fetched, and the execution of the code sequences, where a sequence is a succession of control words, can be initiated. Then, when the correct or true outcome is determined, the sequence of control words associated with the correct outcome proceeds, while execution of the incorrect outcome is halted. In other embodiments, the two or more potential compiled outcomes are executed on spatially separate compute elements within the array of compute elements. The spatially separate compute elements can reduce or eliminate resource contention within the array of CEs. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

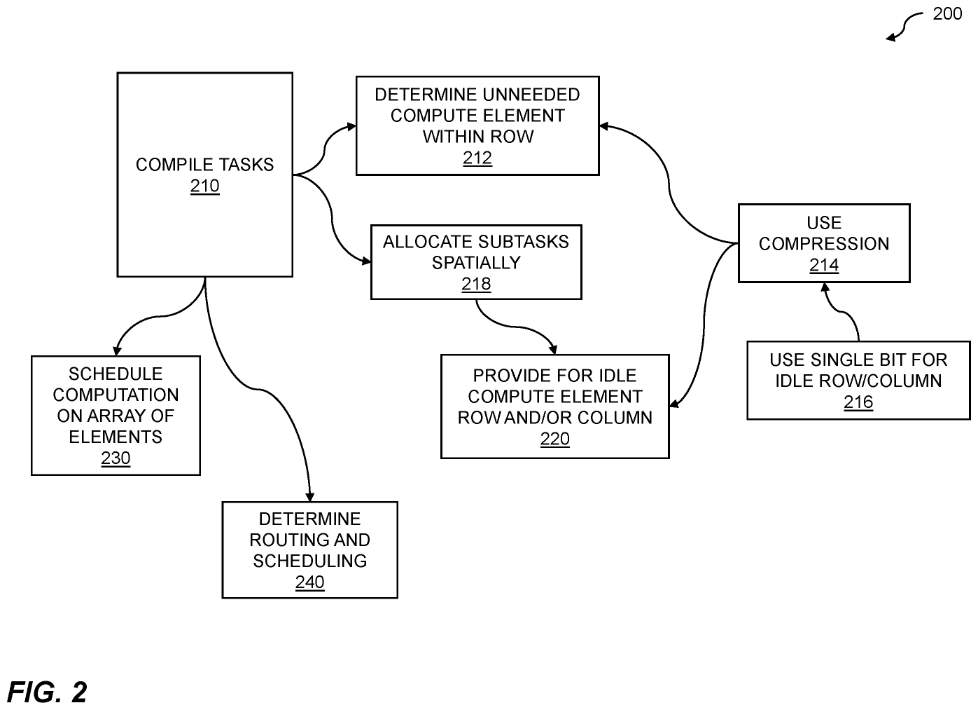

FIG. 2 is a flow diagram for task scheduling. Discussed throughout, tasks can be processed on an array of compute elements. The task can include general operations such as arithmetic, vector, or matrix operations; operations based on applications such as neural network or deep learning operations; and so on. In order for the tasks to be processed correctly, the tasks must be scheduled on the array of compute elements. Scheduling the tasks can be performed to maximize task processing throughput, to ensure that a task that generates data for a second task is processed prior to processing of the second task, and so on. The task scheduling enables a highly parallel processing architecture with a shallow pipeline. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, microcode control words generated by the compiler. The control words are decompressed (in parallel, not sequentially) on a per element basis. A compiled task is executed on the array of compute elements, based on the decompressing.

The flow 200 includes compiling tasks 210 for execution on a two-dimensional array of compute elements. Recall that each of the compute elements within the array is known to the compiler, so that the compiler can generate, if needed, a bunch for each of the compute elements. The compiler can include a general-purpose compiler such as a C, C++, or Python compiler; a hardware-oriented compiler such as a VHDL or Verilog compiler; etc. In embodiments, the compiler enables the array of compute elements to act as a software-defined processor. In the flow 200, the compiled task can determine 212 an unneeded compute element within a row of compute elements in the array of compute elements. A row of compute elements within an array of compute elements can include a number of compute elements, where the number of compute elements can include 2, 4, 8, 16, etc. compute elements. A compiled task can be executed in one or more compute elements. If fewer than the full complement of compute elements within a row is required for execution of a task, then the unneeded compute elements can be marked as unneeded. The flow 200 includes using compression 214 to reduce the size of control words generated by the compiler. The compression can be used to increase functional density of the control words, where the increase in functional density, also known as an increase in information density, enables a reduction in storage requirements for the control words. In embodiments, the compression can include lossless compression. In the flow 200, the unneeded compute element or idle row/column, can be controlled by a single bit 216 in the control word. Setting the bit indicating that the compute element is unneeded for a given task can further improve compression since further information, such as control information for the unneeded compute element, can be eliminated from the control word.

In the flow 200, the compiled task includes a spatial allocation 218 of subtasks on one or more compute elements within the array of compute elements. A given task can comprise a plurality of subtasks. The subtasks can be distributed across the array of compute elements based on compute element availability, task precedence, task order, and the like. Spatial allocation of subtasks can include allocating subtasks to unused processing elements within a row or a column of the array. In the flow 200, the spatial allocation provides for an idle compute element row and/or column 220 in the array of compute elements. That is, instead of simply assigning a subtask to a random compute element, the subtasks can be assigned to unused compute elements within rows or columns that already include assigned compute elements. Thus, unused compute elements can be “accumulated” or collected into columns and rows, and the columns and rows can be marked as unneeded. The providing for idle compute element rows and/or columns further enables compression of compiled control words by eliminating the need for control words for the unneeded rows and/or columns.

In the flow 200, the compiled task schedules computation 230 on the array of compute elements. The scheduling of computation on the array of compute elements can be dependent on the tasks and subtasks that are being scheduled. The scheduling can be based on task precedence or priority, compute element availability, data availability, and so on. The scheduling can be based on system management of the array of compute elements. In embodiments, the computation that is scheduled includes compute element placement, results routing, and computation wave-front propagation within the array of compute elements. The scheduling can further be based on power consumption, heat dissipation, processing speed, and the like. The flow 200 can include determining routing and scheduling 240 within the array of compute elements. The determining routing and scheduling can be based on choosing the shortest communications paths between and among compute elements; organizing data within one or more levels of cache accessible to the compute elements; minimizing access to storage beyond the one or more levels of cache; and so on. The computation wavefront can include routing through an element without that element actually manipulating the data passing through it. For example, an arithmetic logic unit (ALU) can allow routed information to pass through untouched. Likewise, a ringbus structure for inter-element communication can allow routed information for pass through untouched. In addition, the computation wavefront can include data that has been temporarily “parked”, that is, stored for later use, within a memory element of a compute array system. For example, the temporary parking can occur within a ringbus register, a local memory element, a compute element memory, and so on. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

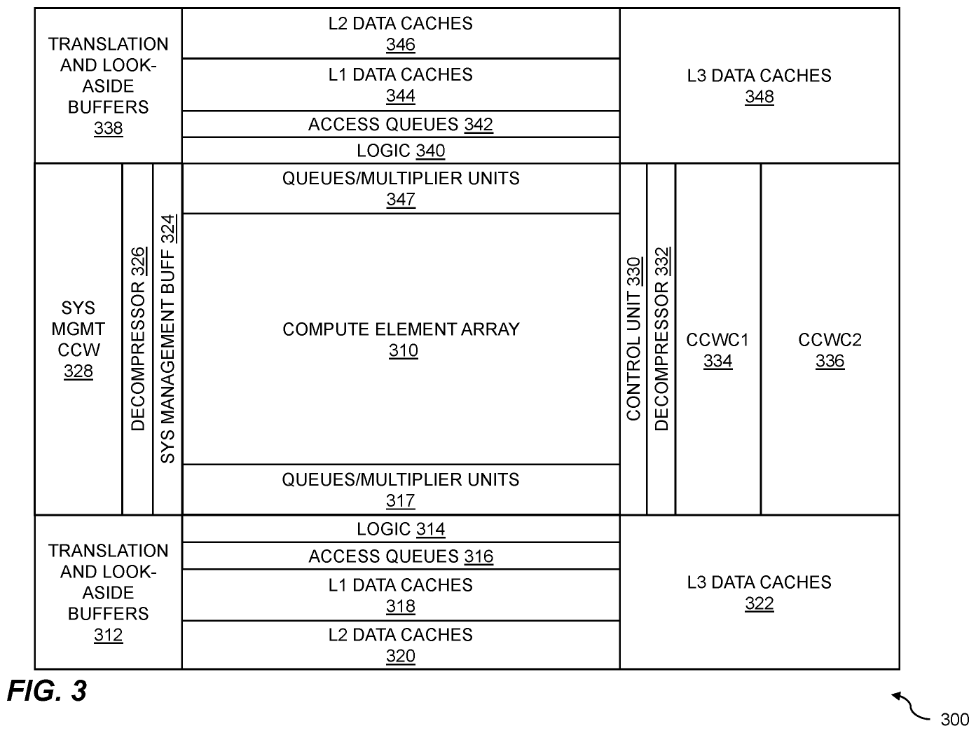

FIG. 3 shows a system block diagram for a highly parallel architecture with a shallow pipeline. The shallow pipeline primarily refers to the pipeline for the compressed control word fetch and decompress functions disclosed herein. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The task processing is enabled using a parallel processing architecture with a shallow pipeline. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, microcode control words generated by the compiler. The control words are decompressed on a per element basis. In addition, there may be global control information in a control word that is not associated with any given control element, such as next compressed control word (CCW) fetch address, control information for queues and other elements, information for hazard detection logic, etc. A compiled task is executed on the array of compute elements, based on the decompressing.

A system block diagram 300 for a highly parallel architecture with a shallow pipeline is shown. The system block diagram can include a compute element array 310. The compute element array 310 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 300 can include translation and look-aside buffers such as translation and look-aside buffers 312 and 338. The translation and look-aside buffers can comprise memory caches, where the memory caches can be used to reduce storage access times. The system block diagram can include logic for load and access order and selection. The logic for load and access order and selection can include logic 314 and logic 340. Logic 314 and 340 can accomplish load and access order and selection for the lower data block (316, 318, and 320) and the upper data block (342, 344, and 346), respectively. This layout technique can double access bandwidth, reduce interconnect complexity, and so on. Logic 340 can be coupled to compute element array 310 through the queues, address generators, and multiplier units 347 component. In the same way, logic 314 can be coupled to compute element array 310 through the queues, address generators, and multiplier units 317 component.

The system block diagram can include access queues. The access queues can include access queues 316 and 342. The access queues can be used to queue requests to access caches, storage, and so on, for storing data and loading data. The system block diagram can include level 1 (L1) data caches such as L1 caches 318 and 344. The L1 caches can be used to store blocks of data such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 320 and 346. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 322 and 348. The L3 caches can be larger than the L2 and L1 caches and can include slower storage. Accessing data from L3 caches is still faster than accessing main storage. In embodiments, the L1, L2, and L3 caches can include 4-way set associative caches.

The block diagram 300 can include a system management buffer 324. The system management buffer can be used to store system management codes or control words that can be used to control the array 310 of compute elements. The system management buffer can be employed for holding opcodes, codes, routines, functions, etc. which can be used for exception or error handling, management of the parallel architecture for processing tasks, and so on. The system management buffer can be coupled to a decompressor 326. The decompressor can be used to decompress system management compressed control words (CCWs) from system management compressed control word buffer 328 and can store the decompressed system management control words in the system management buffer 324. The compressed system management control words can require less storage than the uncompressed control words. The system management CCW component 328 can also include a spill buffer. The spill buffer can comprise a large static random-access memory (SRAM) which can be used to support multiple nested levels of exceptions.

The compute elements within the array of compute elements can be controlled by a control unit such as control unit 330. While the compiler, through the control word, controls the individual elements, the control unit can pause the array to ensure that new control words are not driven into the array. The control unit can receive a decompressed control word from a decompressor 332. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 334. CCWC1 can include a cache such as an L1 cache that includes one or more compressed control words. CCWC1 can be coupled to a further compressed control word store such as compressed control word cache 2 (CCWC2) 336. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 332 can be coupled between CCWC1 334 (now DCWC1) and CCWC2 336.

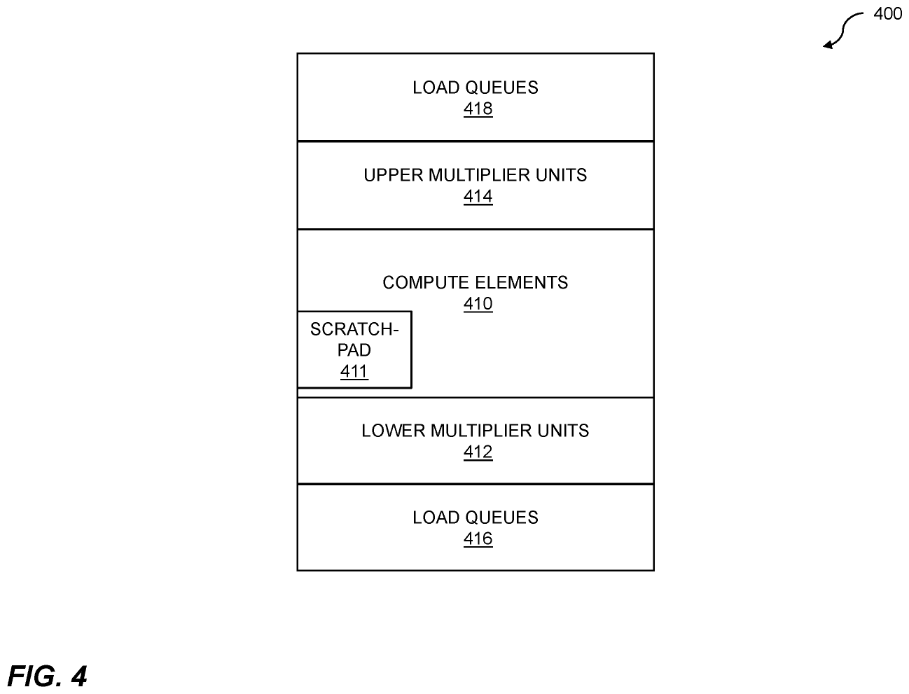

FIG. 4 illustrates compute element array detail 400. A compute element array can be coupled to components which enable the compute elements to process one or more tasks, subtasks, and so on. The components can access and provide data, perform specific high-speed operations, and the like. The compute element array and its associated components enable a parallel processing architecture with a shallow pipeline. The compute element array 410 can perform a variety of processing tasks, where the processing tasks can include operations such as arithmetic, vector, or matrix operations; audio and video processing operations; neural network operations; etc. Each compute element of the compute element array 410 can contain one or more scratchpad memory elements 411. The scratchpad memory elements can be an integral part of a compute element. The scratchpad memory elements can function as a level 0 (L0) cache for an individual compute element. The scratchpad memory elements can function as register files for each individual CE. The compiler can organize a plurality of CE register files as a larger, many-ported register file.

The compute elements can be coupled to multiplier units such as lower multiplier units 412 and upper multiplier units 414. The multiplier units can be used to perform high-speed multiplications associated with general processing tasks, multiplications associated with neural networks such as deep learning networks, multiplications associated with vector operations, and the like. The compute elements can be coupled to load queues such as load queues 416 and load queues 418. The load queues can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

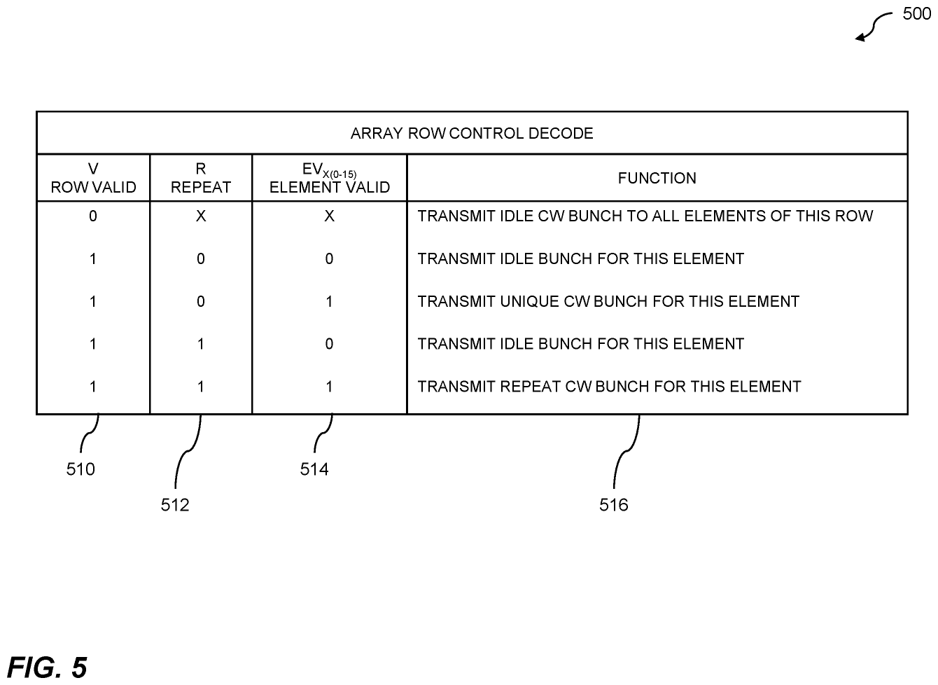

FIG. 5 shows array row control decode. A control word such as a compressed control word can be decompressed and decoded. The decoded control word can be used to provide control to compute elements within a row or a column of an array of compute elements. The array row control decode enables a highly parallel processing architecture with a shallow pipeline. A two-dimensional (2D) array of compute elements is accessed, where each compute element within the array of compute elements is known to a compiler and is coupled to its neighboring compute elements within the array of compute elements. Control for the array of compute elements is provided on a cycle-by-cycle basis, where the control is enabled by a stream of wide, variable length, microcode control words generated by the compiler. The control words are decompressed on a per element basis, and a compiled task is executed on the array of compute elements, based on the decompressing.

An example for compute element array row control decode is shown 500. The row decode can include a row valid field V 510. The row valid field can be used to indicate whether a row of compute elements within the array of compute elements is valid (V=one) or invalid (V=zero). If V is equal to zero, then the row of compute elements is idle, and an idle control word can be decoded and transmitted to all compute elements within the row of compute elements. Row control decode can include a repeat field R 512. The repeat field can be used to indicate whether the control word for each compute element within the row is unique to the compute element (R=zero), or whether control words can be shared or repeated between or among elements. A control word can be associated with an element valid (EV) bit 514. If an EV bit is not set (e.g., is equal to zero), then an idle bit can be transmitted and the previous control word can be sent to a given compute or other element within the array. The various functions that can be performed based on row valid V, repeat R, and element valid (EV) are shown 516. The various functions can include transmitting idle bits to all elements, transmitting an idle bit for a given element, transmitting a unique control word, and transmitting a repeated control word for a given element.

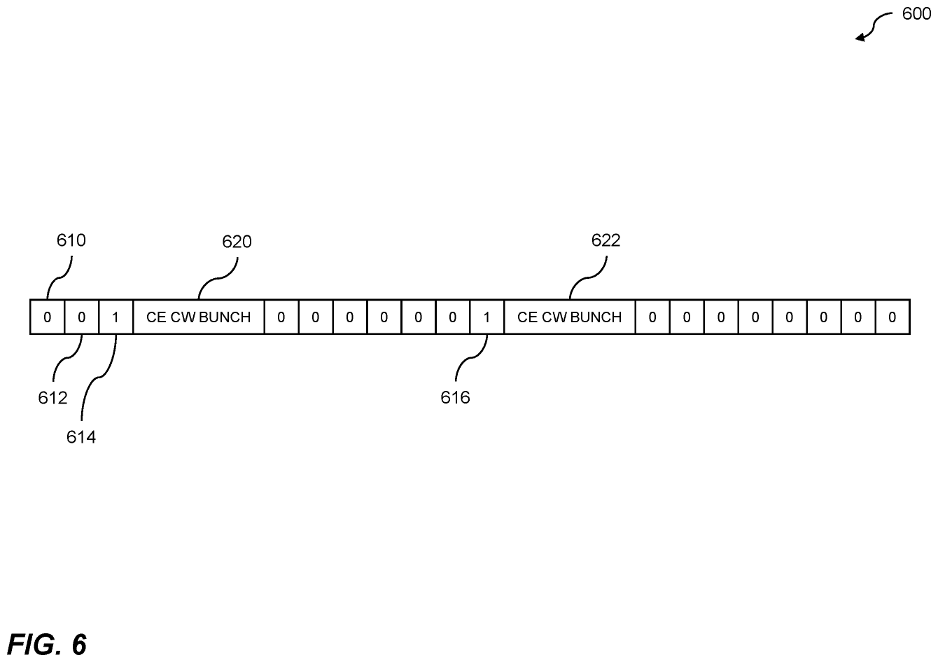

FIG. 6 illustrates example encoding for a single control word row 600. Elements such as compute elements within a row of compute elements can be controlled such that some or all of the compute elements can be enabled for processing a task. The determination of whether a given compute element is active can be based on a bit, such as an element valid (EV) bit, associated with each compute element. In embodiments, all of the compute elements within a row of the array of compute elements can remain idle. The row of compute elements can remain idle due to pending data, pending processing tasks, and so on. In embodiments, the idle compute element row can be controlled by a single bit in the control word. The single control bit can include a leading control bit. In embodiments, a column of compute elements within the array of compute elements can be idle, and the idle compute element column can be controlled by a single bit in the control word. Control word encoding for a single compute element row enables a highly parallel processing architecture with a shallow pipeline. A two-dimensional (2D) array of compute elements is accessed. Control for the array of compute elements is provided on a cycle-by-cycle basis, wherein the control is enabled by a stream of wide, variable length, microcode control words generated by a compiler. The control words are decompressed on a per element basis, and a compiled task is executed on the array of compute elements.

An example encoding for a single compute element row is shown. The encoding can include a single bit 610 which can be used to indicate whether a given row of compute elements is idle. Similarly, a single bit can be included to indicate that a given column of compute elements is idle or not (not shown). The encoding can include bits such as element valid (EV) bits associated with each compute element within the row or column of compute elements. Example bits associated with computer elements include 612, 614, and 616. In the example encoding, the compute element referenced by bit 612 can be idle (=zero). The bits referenced by bits 614 and 616 can be active (=one). Thus, the example encoding can indicate that two compute elements within the row of compute elements are active, while other compute elements within the row remain idle. The example encoding for a single compute element row can include fields or “bunches” for compute element control word bits. Two example fields are shown, field 620 and field 622. The control word bunches can include control bits for a type of element, where the type of element can include a compute element, a multiply element, and so on.

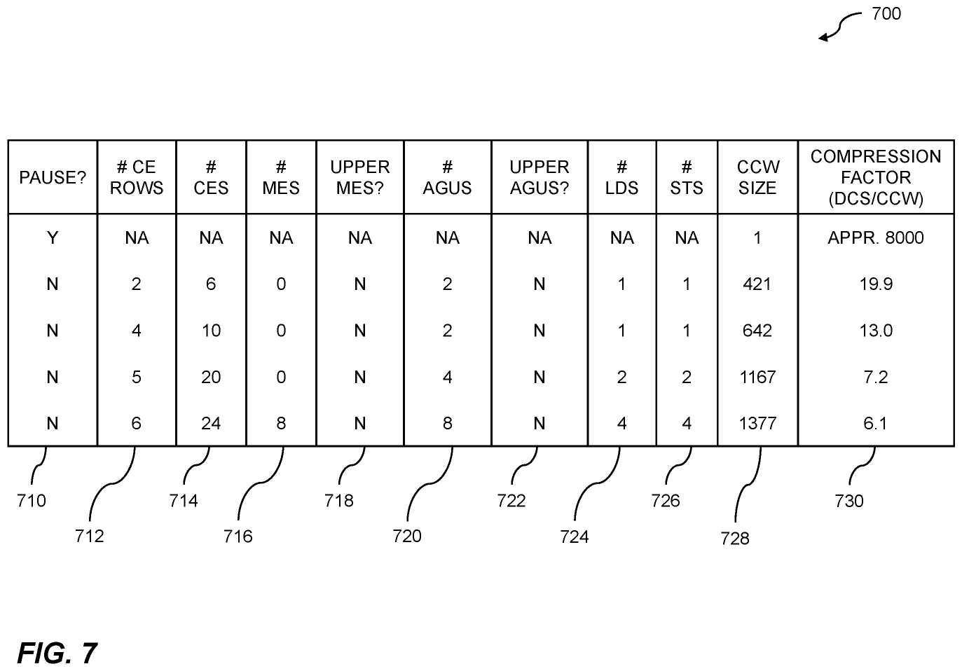

FIG. 7 shows example compressed control word sizes. Control words, which are used to control compute elements within an array of compute elements, can be generated by a compiler. The generated control words can be compressed in order to reduce storage requirements associated with the compiled control words. The compressed control words can be decompressed, and the decompressed control words can be used to control the compute elements within the array of compute elements. Compressed control words enable a highly parallel processing architecture with a shallow pipeline. A 2D array of compute elements is accessed. Each compute element within the array of compute elements is known to a compiler and is coupled to its neighboring compute elements within the array. Control for the array of compute elements is provided on a cycle-by-cycle basis. The control words are decompressed on a per element basis, and a compiled task is executed on the array of compute elements.

Control words provided to control the array of compute elements can be compressed 700. Depending on the purpose of a given control word and the numbers of compute elements and other elements associated with the given control word, varying amounts of compression can be achieved. The amounts of compression that can be achieved for a control word can be compared to a baseline, such as comparison to an x86 instruction. The control words are compressed in order to reduce computational requirements for the array of compute requirements with regard to storage of the control words. The example compressed control word (CCW) can include a “pause” 710. The pause discontinues operation of the array of compute elements (CEs) and no operations are performed while in a pause. A pause can be used to handle stalls that can occur due to cache misses when accessing data to be processed by compute elements. The CCW can control a number of rows of CEs 712 within the array. The CCW can control a number of CEs 714, where the CEs can include CEs within a row. The CEs can be controlled by a processing element valid (EV) bit. Controlling more rows of CEs at a time achieves an economy of scale with respect EV bits of the CCW. The CCW can control the number of multiply elements (MEs) 716 and whether upper multiply elements (MEs) 718 are used. In the example, the number of MEs can include 32 MEs. The CCW can control a number of address generator units (AGUs) 720. Increasing numbers of AGUs can be associated with an increasing number of compute elements. The CCW can control upper AGUs 722 and lower AGUs (not shown). The CCW can control a number of load operations (LD) 724 and a number of store (ST) 726 operations. The numbers of LD and ST operations can be dependent on the types of tasks being processed on the CEs.

The size of a compressed control word can vary 728. In embodiments, the control word can include a control word within a plurality of control words, where the control words comprise a stream of wide, variable length, microcode control words generated by the compiler. The size in bits of a CCW can vary based the numbers of CEs, MEs, AGUs, and LD and ST operations performed by compute elements within the array of compute elements. The amount of compression 730 that can be achieved for a control word with respect to a baseline such as an x86 instruction depends on the number of CEs, MEs, AGUs, data operations, etc. associated with a given CCW. The amount of compression or compression factor may be reduced based on the complexity of the control performed by the CCW.

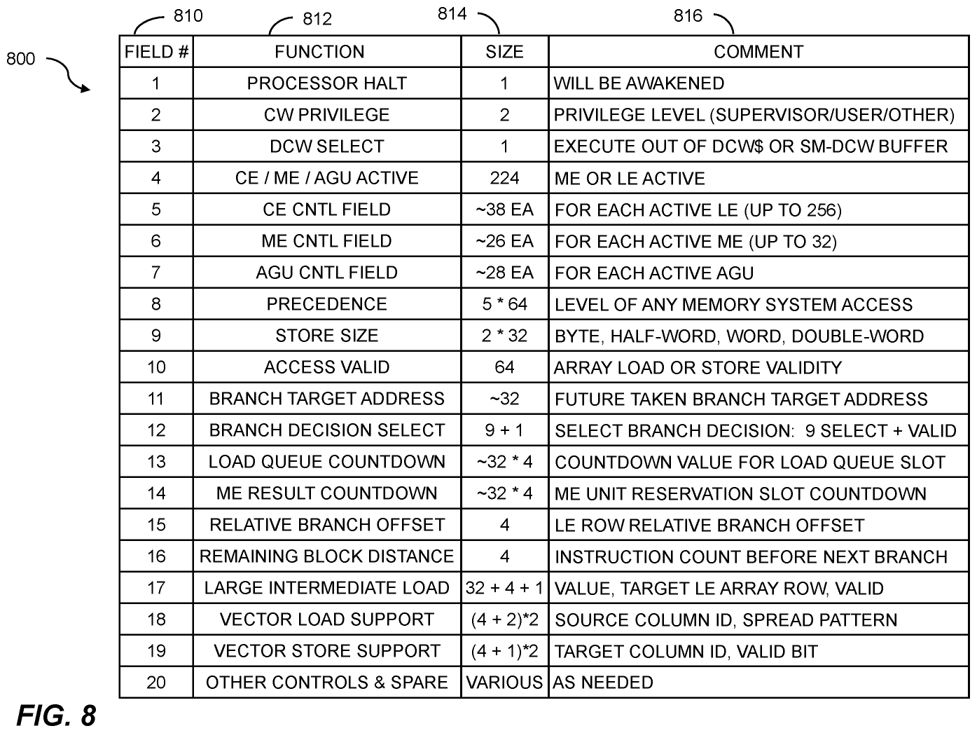

FIG. 8 is a table showing example decompressed control word fields. Discussed throughout, control can be provided to an array of compute elements. The control of the array is enabled by a stream of microcode control words, where the microcode control words can be generated by a compiler. The microcode control word, which comprises a plurality of fields, can be stored in a compressed format to reduce storage requirements. The compressed control word can be decompressed in order to enable control of one or more compute elements within the array of compute elements. The fields of the decompressed control word enable a highly parallel processing architecture with a shallow pipeline. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, microcode control words generated by the compiler. The control words are decompressed on a per element basis, such that the control word, once decompressed, can control an entire array of compute elements (or any subset of compute elements) on a cycle-by-cycle basis. A compiled task is executed on the array of compute elements, based on the decompressing.

A table 800 depicting control word fields for a decompressed control word is shown. The decompressed control word comprises fields 810. While 20 fields are shown, other numbers of fields can be included in the decompressed control word. The number of fields can be based on a number of compute elements within an array, processing capabilities of the compute elements, compiler capabilities, requirements of processing tasks, and so on. Each field within the decompressed control word can be assigned a purpose or function 812. The function of a field can include providing, controlling, etc., commands, data, addresses, and so on. In embodiments, the one or more fields within the decompressed control word can include spare bits. Each field within the decompressed control word can include a size 814. The size can be based on a number of bits, although other bit groupings can be specified, such as nibbles, bytes, and the like. Comments 816 can also be associated with fields within the decompressed control word. The comments further explain the purpose, function, etc., of a given field.

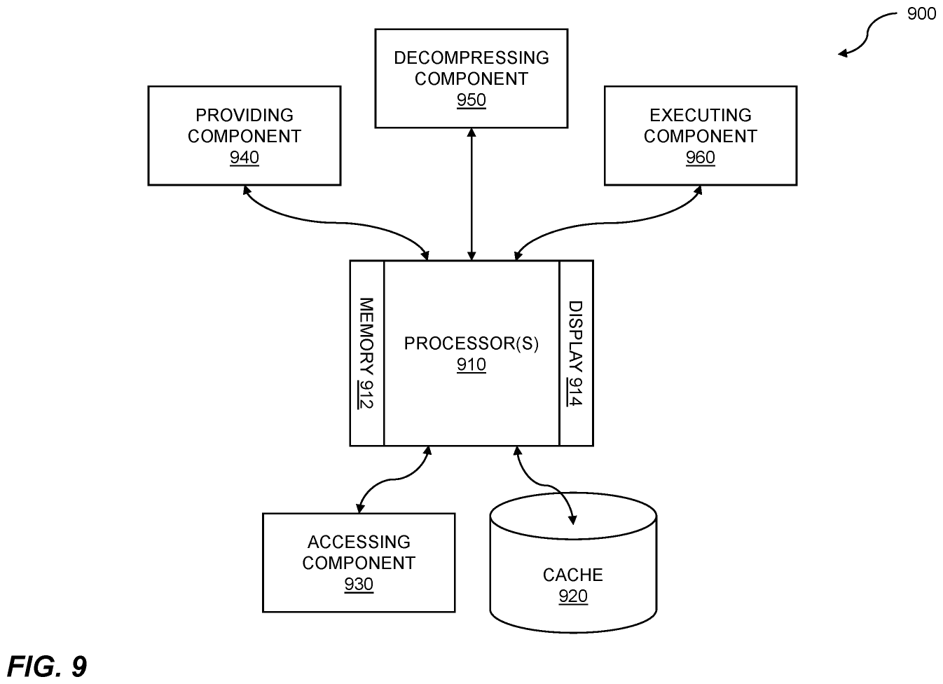

FIG. 9 is a system diagram for task processing. The task processing is performed using a highly parallel processing architecture with a shallow pipeline. The system 900 can include one or more processors 910, which are attached to a memory 912 which stores instructions. The system 900 can further include a display 914 coupled to the one or more processors 910 for displaying data; intermediate steps; control words; control words implementing Very Long Instruction Word (VLIW) functionality; topologies including systolic, vector, cyclic, spatial, streaming, or VLIW topologies; and so on. In embodiments, one or more processors 910 are coupled to the memory 912, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide, variable length, microcode control words generated by the compiler; decompress the control words on a per element basis; and execute a compiled task on the array of compute elements, based on the decompressing. Further embodiments include storing relevant portions of the control word within a cache associated with the array of compute elements (discussed below). The compute elements can include compute elements within one or more integrated circuits or chips; compute elements or cores configured within one or more programmable chips such as application specific integrated circuits (ASICs); field programmable gate arrays (FPGAs); processors configured as a mesh; standalone processors; etc.

The system 900 can include a cache 920. The cache 920 can be used to store data, control words, intermediate results, microcode, and so on. The cache can comprise a small, local, easily accessible memory available to one or more compute elements. Embodiments include storing relevant portions of a control word within the cache associated with the array of compute elements. The cache can be accessible to one or more compute elements. In embodiments, the cache comprises a dual read, single write (2R1 W) cache. That is, the 2R1 W cache can enable two contemporaneous read operations and one write operation without the read and write operations interfering with one another. The system 900 can include an accessing component 930. The accessing component 930 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ringbus, a network such as a computer network, etc. In embodiments, the ringbus is implemented as a distributed multiplexor (MUX). In other embodiments, the 2R1 W cache can support simultaneous fetch of potential branch paths for the compiled task. Since the branch path taken by a branch control word can be data dependent and is therefore not known a priori, then control words associated with more than one branch path can be fetched prior to execution of the branch control word. As discussed previously, initial parts of both branch paths can be instantiated in a succession of control words. When the correct branch path is determined, the computations associated with the untaken branch can be flushed and/or ignored.

The system 900 can include a providing component 940. The providing component 940 can include control and functions for providing control for the array of compute elements on a cycle-by-cycle basis, wherein the control is enabled by a stream of wide, variable length, microcode control words generated by the compiler. The control of the array of compute elements can include configuring the array to perform various compute operations. The compute operations can enable audio or video processing, artificial intelligence processing, deep learning, and the like. The microcode control words can include opcode fields, data fields, compute array configuration fields, etc. The compiler that generates the microcode can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the array of compute elements can include a systolic, a vector, a cyclic, a spatial, a streaming, or a Very Long Instruction Word (VLIW) topology. Other topologies can include a neural network topology. A control word that can be associated with one or more compute elements within the array need not be stored by a single compute element. In embodiments, the cache 920 enables the control word to be distributed across a row of the array of compute elements.

The system 900 can include a decompressing component 950. The decompressing component 950 can include control logic and functions for decompressing the control words on a per element basis, where each control word can be comprised of a plurality of compute element control groups or bunches. One or more control words can be stored in a compressed format within a memory such as the cache. The compression of the control words can reduce storage requirements, complexity of decoding components, and so on. A substantially similar decompression technique can be used to decompress control words for each compute element, or more than one decompression technique can be used. The compression of the control words can be based on compute cycles associated with the array of compute elements. In embodiments, the decompressing can occur cycle-by-cycle out of the cache. The decompressing of control words for one or more compute elements can occur cycle-by-cycle. In other embodiments, decompressing of a single control word can occur over multiple cycles.

The system 900 can include an executing component 960. The executing component 960 can include control logic and functions for executing a compiled task on the array of compute elements, based on the decompressing. The compiled task, which can be one of many tasks associated with a processing job, can be executed on one or more compute elements within the array of compute elements. In embodiments, the executing of the compiled task can be distributed across compute elements in order to parallelize the execution. The executing the compiled task can include executing the tasks for processing multiple datasets (e.g., single instruction multiple data or SIMD execution). Embodiments can include providing simultaneous execution of two or more potential compiled task outcomes. The two or more potential compiled task outcomes can be based on one or more branch paths, data, etc. The executing can be based on one or more control words. In embodiments, the same control word can be executed on a given cycle across the array of compute elements. The executing tasks can be performed by compute elements located throughout the array of compute elements. In embodiments, the two or more potential compiled outcomes can be executed on spatially separate compute elements within the array of compute elements. Using spatially separate compute elements can enable reduced storage, bus, and network contention; reduced power dissipation by the compute elements; etc.

The system 900 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, microcode control words generated by the compiler; decompressing the control words on a per element basis; and executing a compiled task on the array of compute elements, based on the decompressing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, microcode control words generated by the compiler;
decompressing the control words to enable control on a per element basis; and
executing a compiled task on the array of compute elements, wherein the executing is based on the control words that were decompressed.

2. The method of claim 1 further comprising storing relevant portions of the control word within a cache associated with the array of compute elements.

3. The method of claim 2 wherein the decompressing occurs cycle-by-cycle out of the cache.

4. The method of claim 3 wherein decompressing of a single control word occurs over multiple cycles.

5. The method of claim 4 wherein the multiple cycles accommodate control word straddle over a cache line fetch boundary.

6. The method of claim 2 wherein the cache comprises a dual read, single write (2R1 W) cache.

7. The method of claim 6 wherein the 2R1 W cache supports simultaneous fetch of potential branch paths for the compiled task.

8. The method of claim 2 wherein the cache enables the control word to be distributed across a row of the array of compute elements.

9. The method of claim 8 wherein the distribution across a row of the array of compute elements is accomplished in one cycle.

10. The method of claim 1 further comprising providing simultaneous execution of two or more potential compiled task outcomes.

11. The method of claim 10 wherein the two or more potential compiled task outcomes comprise a computation result or a routing control.

12. The method of claim 10 wherein the two or more potential compiled outcomes are controlled by the same control word.

13. The method of claim 12 wherein the same control word is executed on a given cycle across the array of compute elements.

14. The method of claim 13 wherein the two or more potential compiled outcomes are executed on spatially separate compute elements within the array of compute elements.

15. The method of claim 1 wherein the compiled task determines an unneeded compute element within a row of compute elements within the array of compute elements.

16. The method of claim 15 wherein the unneeded compute element is controlled by a single bit in the control word.

17. The method of claim 1 wherein the compiled task includes a spatial allocation of subtasks on one or more compute elements within the array of compute elements.

18. The method of claim 17 wherein the spatial allocation provides for an idle compute element row and/or column in the array of compute elements.

19. The method of claim 18 wherein the idle compute element row is controlled by a single bit in the control word.

20. The method of claim 18 wherein the idle compute element column is controlled by a single bit in the control word.

21. The method of claim 1 wherein the compiled task schedules computation in the array of compute elements.

22. The method of claim 21 wherein the computation includes compute element placement, results routing, and computation wave-front propagation within the array of compute elements.

23. The method of claim 1 wherein compute elements within the array of compute elements have identical functionality.

24. (canceled)

25. The method of claim 1 wherein the compiled task includes multiple programming loop instances circulating within the array of compute elements.

26-28. (canceled)

29. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, microcode control words generated by the compiler;
decompressing the control words to enable control on a per element basis; and
executing a compiled task on the array of compute elements, wherein the executing is based on the control words that were decompressed.

30. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide, variable length, microcode control words generated by the compiler;
decompress the control words to enable control on a per element basis; and
execute a compiled task on the array of compute elements, wherein the executing is based on the control words that were decompressed.
